(19) United States
(12) Patent Application Publication
(10) Pub. No.: US 2013/0279656 A1
(43) Pub. Date: Oct. 24, 2013

(54) RADIATION IMAGING APPARATUS, RADIATION IMAGING SYSTEM, METHOD OF CONTROLLING RADIATION IMAGING APPARATUS AND STORAGE MEDIUM

(71) Applicant: CANON KABUSHIKI KAISHA, Tokyo (JP)

(72) Inventor: Tadahiko Iijima, Yokohama-shi (JP)

(73) Assignee: CANON KABUSHIKI KAISHA, TOKYO (JP)

(21) Appl. No.: 13/860,762

(22) Filed: Apr. 11, 2013

(30) Foreign Application Priority Data
Apr. 19, 2012 (JP) 2012-096038

(51) Int. Cl. G21K 1/14

(52) U.S. Cl. CPC G21K 1/14
USPC 378/62

(57) ABSTRACT

A radiation imaging apparatus comprising: an obtaining unit configured to obtain rotation control information of a positive electrode of a rotating positive electrode type radiation generating apparatus; an accumulation unit configured to accumulate charge; a readout unit configured to read out the charge based on the rotation control information while a rotational speed of the positive electrode is constant; and an image generating unit configured to generate an image by reading out the charge.

### BACKGROUND OF THE INVENTION

1. Field of the Invention

The present invention relates to a radiation imaging apparatus which obtains, as an image, the intensity distribution of radiation transmitted through an object, a radiation imaging system, a method of controlling the radiation imaging apparatus, and a storage medium.

2. Description of the Related Art

There have been commercially available a radiation imaging apparatus which generates a clear radiation image by irradiating an object with radiation from a radiation generating apparatus, digitizing, as a radiation image, the intensity distribution of the radiation transmitted through the object, and performing image processing for the image, and a radiation imaging system including the radiation imaging apparatus.

In such a radiation imaging system, a radiation generating apparatus irradiates radiation and transfers the radiation image data obtained by a radiation imaging apparatus to an image processing apparatus such as a control computer for image processing and storage. The image processing apparatus causes a display apparatus such as a display to display a processed image. The radiation imaging apparatus is formed by stacking phosphors on pixels formed by photoelectric conversion elements and the like. The radiation imaging apparatus converts radiation into visible light by using phosphors, and holds the visible light as charge, thereby generating an image from the amount of charge read out. In this case, a dark current exists in each captured pixel. Under the circumstance, there is known a method of obtaining a clear image by correcting the influence of a dark current.

Japanese Patent No. 4352057 discloses a technique of correcting the influence of a dark current by performing imaging without radiation irradiation after radiation imaging under the same conditions as those for radiation imaging. A positive electrode type radiation generating apparatus which rotates and cools the positive electrode is known. Many high output radiation generating apparatuses are rotating positive electrode type apparatuses which can accumulate a large amount of heat in the positive electrode. A rotating positive electrode type radiation generating apparatus is designed to rotate the positive electrode by using a rotor. As a method of rotating the rotor, there is known a method of performing rotation control by making a magnetic field vary by controlling a current flowing in the coil. The radiation generating apparatus starts rotating the positive electrode before radiation irradiation and stops the rotation after radiation irradiation. The magnetic field varies differently when the rotational speed increases, decreases, and remains constant. For this reason, when the radiation imaging apparatus performs imaging near the rotating positive electrode type radiation generating apparatus, the imaging apparatus receives the influence of magnetic field variation due to rotor control. As a result, an induced current flows in a circuit for reading out charge from the image sensor in the radiation imaging apparatus and determining a charge value, and the circuit outputs, as a charge value, a value different from that held in the image sensor. This may cause artifacts in a generated image.

Japanese Patent No. 4726461 discloses a technique of preventing the occurrence of magnetic field variations by performing rotation control on the positive electrode using a spring.

The method disclosed in Japanese Patent No. 4726461, however, cannot reduce the possibility of the occurrence of artifacts in an image due to the influence of a rotor when using a rotating positive electrode type radiation generating apparatus which performs rotation control on the positive electrode by using the coil.

In addition, when using the method disclosed in Japanese Patent No. 4352057, a deceleration or acceleration period of the rotation of the positive electrode may overlap a charge readout period due to variations in radiation irradiation time. When these periods overlap, an artifact can occur in an image due to the influence of magnetic field variations.

### SUMMARY OF THE INVENTION

In consideration of the above problem, the present invention provides a technique of reducing the occurrence of artifacts in an image due to the influence of the rotation of the positive electrode of a radiation generating apparatus.

According to one aspect of the present invention, there is provided a radiation imaging apparatus comprising: an obtaining unit configured to obtain rotation control information of a positive electrode of a rotating positive electrode type radiation generating apparatus; an accumulation unit configured to accumulate charge; a readout unit configured to read out the charge based on the rotation control information while a rotational speed of the positive electrode is constant; and an image generating unit configured to generate an image by reading out the charge.

According to one aspect of the present invention, there is provided a radiation imaging apparatus comprising: an obtaining unit configured to obtain rotation control information of a positive electrode of a rotating positive electrode type radiation generating apparatus; an accumulation unit configured to accumulate charge; a readout unit configured to read out the charge based on the rotation control information while a rotational speed of the positive electrode is constant, if preview display is not performed; and an image generation unit configured to generate an image by reading out the charge.

Further features of the present invention will be apparent from the following description of exemplary embodiments with reference to the attached drawings.

### BRIEF DESCRIPTION OF THE DRAWINGS

FIG. 1 is a block diagram showing an example of the arrangement of a radiation imaging system;

FIG. 2 is a chart showing the relationship between the rotational speed of the rotor, the X-ray irradiation timing, and the readout timing of charge held in the image sensor in the an X-ray ray imaging apparatus 110;

FIG. 3 is a chart showing the charge readout timing according to the first embodiment;

FIG. 4 is a chart showing the charge readout timing according to the second embodiment;

FIG. 5 is a flowchart showing a procedure for processing according to the third embodiment;

FIG. 6 is a chart showing the X-ray irradiation timing and the rotor control timing according to the third embodiment; and

FIG. 7 is a chart showing the charge readout timing and the rotor control timing according to the fourth embodiment.

### DESCRIPTION OF THE EMBODIMENTS

Exemplary embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

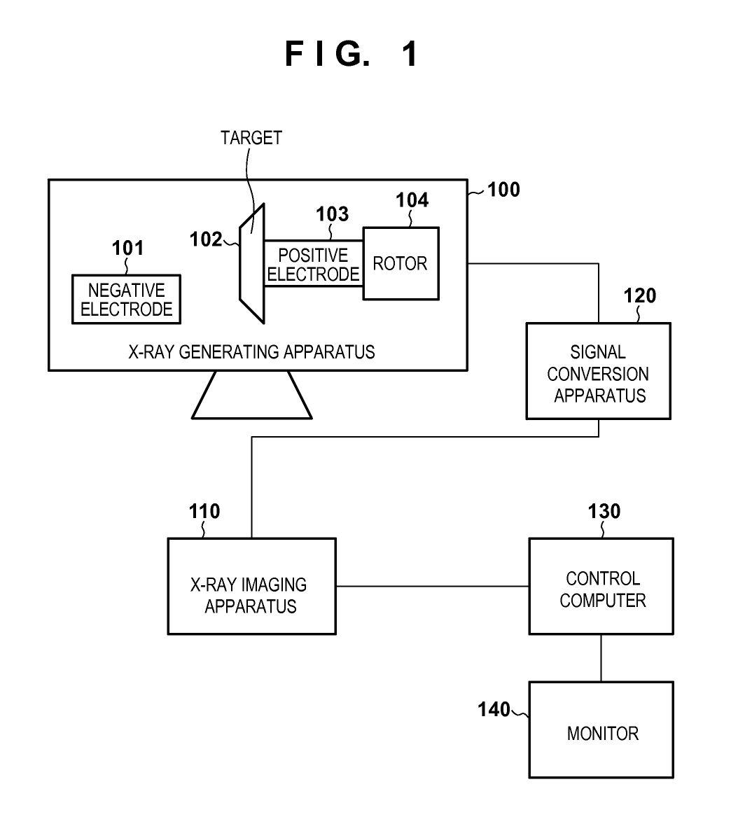

An example of the arrangement of a radiation imaging system will be described with reference to FIG. 1. The following is a case in which X-rays are used as radiation. However, radiation is not limited to X-rays and the present invention can be applied to cases in which other types of radiation such as α-rays, β-rays, and γ-rays are used.

The radiation imaging system includes an X-ray generating apparatus 100, an X-ray imaging apparatus 110, a signal conversion apparatus 120, a control computer 130, and a display 140. The constituent elements of the radiation imaging system are not limited to these apparatuses. The radiation imaging system may not include some of them or may further include other apparatuses. Alternatively, the functions of a plurality of apparatuses may be configured to be executed as one apparatus.

The X-ray generating apparatus 100 is a rotating positive electrode type radiation generating apparatus, which includes a negative electrode 101 which generates electron beams, a target 102 formed from tungsten or the like which generates X-rays upon being bombarded by electron beams, a positive electrode 103 which supports the target 102, and a rotor 104 which rotates the target 102 by using a coil to prevent the target 102 from being heated and fused upon being bombarded by electron beams.

The X-ray imaging apparatus 110 can obtain rotation control information concerning the rotor 104 of the X-ray generating apparatus 100, which indicates states during acceleration, constant speed control, deceleration, stoppage, and the like, via the signal conversion apparatus 120. The signal conversion apparatus 120 converts a signal to exchange information between the X-ray generating apparatus 100 and the X-ray imaging apparatus 110. The control computer 130 controls the X-ray imaging apparatus 110 and performs image processing. The display 140 displays information held by the control computer.

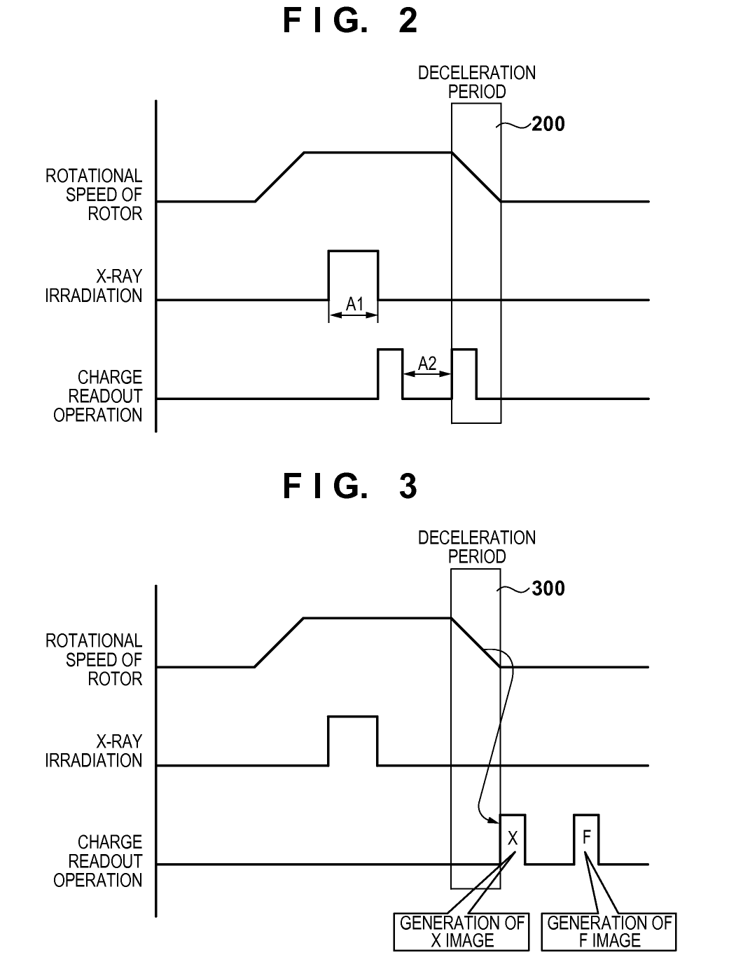

The relationship between the rotational speed of the rotor, the X-ray irradiation timing, and the readout timing of charge held in the image sensor in the X-ray imaging apparatus 110 will be described with reference to FIG. 2. After the rotational speed of the rotor increases to a predetermined rotational speed, X-ray irradiation is performed in an X-ray irradiation time Al. Thereafter, the charge accumulated in the image sensor in the X-ray imaging apparatus 110 by the X-ray irradiation is read out. The apparatus then accumulates charge under the same condition as those for the accumulation of charge by the X-ray irradiation. The apparatus performs charge readout operation in the same manner as described above. To accurately correct the influence of a dark current, the X-ray irradiation time A1 is set equal in length to a second charge accumulation time A2. The apparatus performs this second charge readout processing to correct a dark current portion of the charge read out after first X-ray irradiation. The image generated by charge readout operation immediately after X-ray irradiation is defined as an X image. The image generated by charge readout operation for the correction of the influence of a dark current is defined as an F image. The apparatus calculates the difference (X image−F image) between the X image and the F image to correct the influence of a dark current, and performs correction based on the difference, thereby obtaining a final image. That is, the apparatus generates a corrected radiation image on which the influence of a dark current has been corrected, by subtracting the luminance value of the correction image from the luminance value of the radiation image.

In this case, as the rotational speed of the rotor 104 decreases (period 200) during charge readout processing for the generation of the F image, the magnetic field varies. Artifacts may occur in a generated image due to the influence of this magnetic field variation.

The charge readout timing according to the first embodiment for the reduction of the occurrence of such artifacts will be described with reference to FIG. 3. The X-ray imaging apparatus 110 stops rotation control on the rotor 104 after the end of a deceleration period 300 of the rotor 104, and then generates an X image by reading out charge. Subsequently, the apparatus generates an F image by reading out charge in the same manner as described above to correct the influence of a dark current. The apparatus obtains a final image by performing correction by subtraction between the X image and the F image. Note that when using an X image for preview display, since higher priority is given to display speed than to image quality, it is possible to perform charge readout operation even during the deceleration period 300. That is, the apparatus determines whether to use an X image for preview display, and generates an X image by performing charge readout operation after rotation control on the rotor 104 stops, if the X image is not used for preview display.

As described above, according to this embodiment, since no magnetic field variation due to rotor control occurs during charge readout operation, it is possible to reduce the occurrence of artifacts due to rotor control.

Note that the apparatus may perform only charge readout operation for the generation of an F image after the rotor stops rotating. It is also possible to use a method of grasping a state concerning the rotation of the rotor by measuring the power or current consumption of the X-ray generating apparatus instead of obtaining information concerning a control signal for the rotor from the X-ray generating apparatus 100 via the signal conversion apparatus 120.

### Second Embodiment

The first embodiment has exemplified the arrangement for generating an X image by reading out charge after the rotor 104 stops rotating, and further generating an F image by reading out charge to correct a dark current. In contrast to this, in the second embodiment, the apparatus generates an X image by reading out charge immediately after X-ray irradiation, and determines whether the deceleration period of the rotor overlaps the period during which an F1 image is generated by reading out charge to correct a dark current. If these periods overlap, the apparatus generates an F2 image by further reading out charge to correct a dark current after the lapse of the deceleration period of the rotor. The apparatus then obtains a final image by performing correction based on the difference between the X image and the F2 image. If the periods do not overlap, the apparatus obtains a final image by performing correction based on the difference between the X image and the F1 image. Note that when using an X image for preview display, since higher priority is given to display speed than to image quality, the F1 image may be used for dark current correction even if the deceleration period of the motor overlaps the period during which the F1 image is generated by reading out charge to correct a dark current. That is, the apparatus determines whether the X image is used for preview display, and generates, if the image is not used for preview display, an F2 image by further reading out charge to correct a dark current after the lapse of the deceleration period of the rotor.

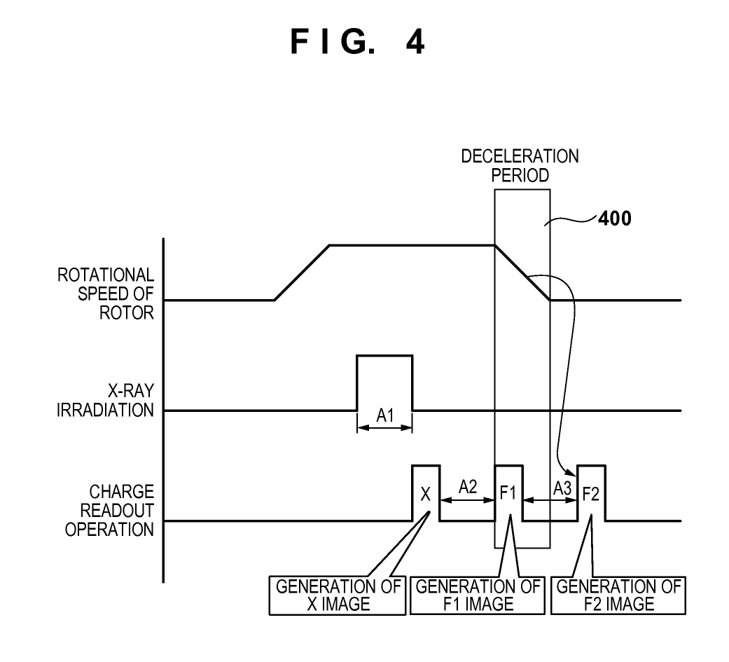

The charge readout timing according to the second embodiment for the reduction of the occurrence of artifacts will be described with reference to FIG. 4. An X-ray imaging apparatus 110 generates an X image by reading out charge immediately after X-ray irradiation. The apparatus then reads out charge for the correction of the influence of a dark current and generates the F1 image. In this case, to accurately correct the influence of a dark current, an X-ray irradiation time A1 is set equal to a charge accumulation time A2 for the generation of the F1 image. If the period during which charge is read out for the generation of the F1 image overlaps a deceleration period 400 of a rotor 104, the apparatus generates the F2 image by reading out charge for dark current correction again after the deceleration period 400 of the rotor 104 ends and the rotor 104 stops rotating. In this case, to accurately correct a dark current, the X-ray irradiation period A1 is set equal to a charge accumulation time A3 for the generation of the F2 image. The apparatus then calculates the difference between the X image and the F2 image, and obtains a final image by performing correction based on the difference. This makes it possible to reduce the occurrence of artifacts due to the rotor in the F2 image for the correction of the influence of a dark current without causing any magnetic field variation due to rotor deceleration control during charge readout operation.

Note that since the readout period for the generation of the F1 image changes with a change in the X-ray irradiation time A1, the X-ray irradiation time determines whether the deceleration period of the rotor overlaps the charge readout period for the generation of the F1 image. For this reason, the apparatus determines whether the period during which charge is read out to generate the F1 image and the deceleration period 400 of the rotor 104 have an overlapping period. If there is no overlapping period, the apparatus may not perform charge readout operation for the generation of the F2 image. The apparatus may calculate the difference between the X image and the F1 image and obtain a final image by performing correction based on the difference.

It is possible to use a method of grasping a state concerning the rotation of the rotor by measuring the power or current consumption of the X-ray generating apparatus instead of obtaining the information of a control signal for the rotor from an X-ray generating apparatus 100 via a signal conversion apparatus 120.

As described above, according to this embodiment, it is possible to obtain an X image by X-ray irradiation before a deceleration period and obtain a final image early after correction when obtaining an F image for correcting the influence of a dark current before a deceleration period of the rotor. Even if an F image is obtained after a deceleration period of the rotor, it is possible to obtain a final image with reduced artifacts originating from the rotor.

### Third Embodiment

The third embodiment will exemplify an arrangement configured to estimate whether charge readout operation is complete before the rotor stops rotating and selectively execute the processing in the first embodiment and the processing in the second embodiment depending on the estimation result.

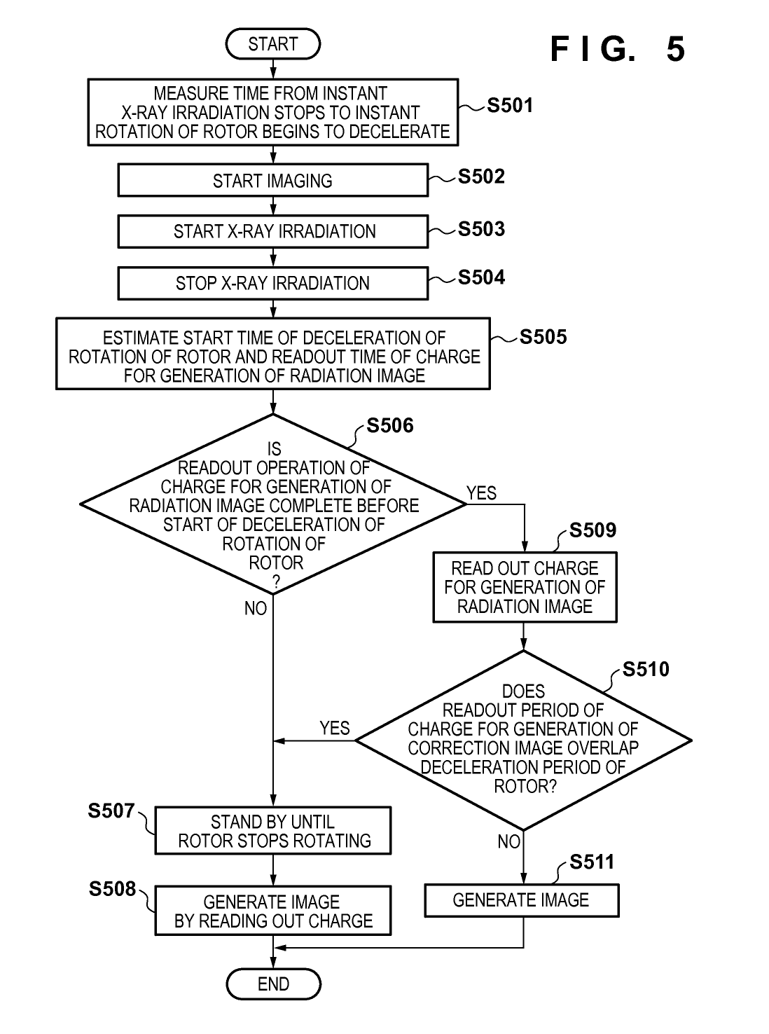

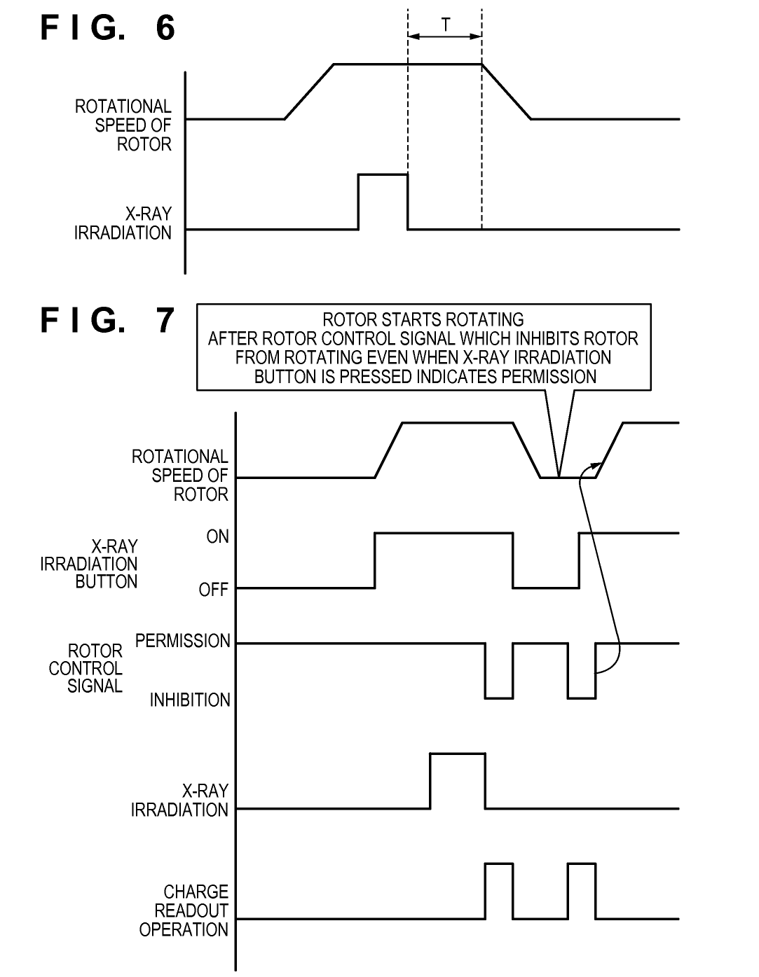

A procedure for processing according to the third embodiment will be described with reference to the flowchart of FIG. 5. In step S501, an X-ray imaging apparatus 110 measures the time from the instant X-ray irradiation stops to the instant the rotor stops driving before imaging operation. FIG. 6 is a timing chart showing the relationship between the rotational speed of the rotor and X-ray irradiation. The time measured in step S501 is a period T from the instant X-ray irradiation stops to the instant the rotor stops driving and the rotational speed of the rotor begins to decrease.

In step S502, the X-ray imaging apparatus 110 starts imaging. In this case, the X-ray imaging apparatus 110 becomes ready for imaging in response to an instruction from a control computer 130. In step S503, an X-ray generating apparatus 100 starts X-ray irradiation in response to the pressing of an irradiation button (not shown) by the user. Assume that in this case, the apparatus rotates a rotor 104 before the start of X-ray irradiation and then starts X-ray irradiation.

In step S504, the X-ray generating apparatus 100 stops X-ray irradiation in response to the time-out of the X-ray irradiation time set in advance or the releasing of the irradiation button by the user. In step S505, the X-ray imaging apparatus 110 estimates a rotor stop time and a charge readout time based on a period T measured in advance in step S501 and the X-ray irradiation time, obtained from steps S503 and S504, during which the X-rays have been actually irradiated.

In step S506, the X-ray imaging apparatus 110 determines, based on the above estimation, whether charge readout operation for the generation of a radiation image is complete before the rotation of the rotor begins to decelerate (within the period T from the stoppage of X-ray irradiation). If the X-ray imaging apparatus 110 determines that the charge readout operation is complete (YES in step S506), the process advances to step S509. If the X-ray imaging apparatus 110 determines that the charge readout operation is not complete (NO in step S506), the process advances to step S507.

In step S507, the X-ray imaging apparatus 110 stands by until the rotor stops. In step S508, the X-ray imaging apparatus 110 generates a radiation image by reading out charge after the rotor stops, and then generates a correction image for correcting the influence of a dark current by further reading out charge after the lapse of a predetermined period. The processing in each of steps S506 to S508 corresponds to image generation according to the first embodiment described with reference to FIG. 3.

In step S509, the X-ray imaging apparatus 110 generates a radiation image by reading out charge for the generation of a radiation image. Thereafter, the X-ray imaging apparatus 110 generates a correction image for the correction of the influence of a dark current by further reading out charge after the lapse of a predetermined period.

In step S510, the X-ray imaging apparatus 110 determines whether the charge readout period for the generation of a correction image overlaps the deceleration period of the rotor. If the X-ray imaging apparatus 110 determines that the periods overlap (YES in step S510), the process returns to step S507. In this case, however, since a radiation image has already been generated, the X-ray imaging apparatus 110 generates, in step S508, a correction image for the correction of the influence of a dark current by reading out charge after the rotor stops. If the X-ray imaging apparatus 110 determines that the periods do not overlap (NO in step S510), the process advances to step S511.

In step S511, the X-ray imaging apparatus 110 generates a correction image for the correction of the influence of a dark current by reading out charge after the lapse of a predetermined period. The series of processing in steps S507 to S511 corresponds to the image generation according to the second embodiment described with reference to FIG. 4. With the above processing, each process in the flowchart of FIG. 5 is complete.

The period from the instant X-ray irradiation stops to the instant the rotor completely stops rotating may be a period T instead of the period from the instant X-ray irradiation stops to the instant the rotational speed of the rotor begins to decrease. If the period T from the instant X-ray irradiation stops to the instant the rotational speed of the rotor begins to decrease is not uniquely determined, the apparatus may perform measurement a plurality of conditions in advance, obtain a function (T=F(t)) for obtaining the period T from the instant X-ray irradiation stops to the instant the rotational speed of the rotor begins to decrease by using the X-ray irradiation time t, and estimate by using the obtained function whether charge readout operation is complete before the rotational speed of the rotor begins to decrease.

As described above, according to this embodiment, the apparatus estimates whether charge readout operation is complete before the rotor stops rotating, and controls the image generation timing in accordance with the estimation result. This makes it possible to execute image generation early when charge readout operation is complete before the rotor stops rotating, as well as being able to execute image generation without causing any artifacts, thereby shortening the processing time.

### Fourth Embodiment

The fourth embodiment will exemplify an arrangement configured to inhibit the rotor from rotating when a rotor control signal synchronized with charge readout operation indicates an inhibition state even if the user presses the X-ray irradiation button. The charge readout timing and the rotor control timing in the fourth embodiment will be described with reference to FIG. 7. An X-ray imaging apparatus 110 transmits a rotor control signal to an X-ray generating apparatus 100 via a signal conversion apparatus 120, and executes driving control on the rotor in accordance with the rotor control signal. If the user presses the X-ray irradiation button when a rotor control permission signal indicates permission, the rotational speed of the rotor increases, and then the apparatus irradiates X-rays. The rotor decelerates and then stops after X-ray irradiation in response to time-out or at the timing when the user stops pressing the X-ray irradiation button. A rotor control signal is controlled in synchronism with charge readout operation to indicate an inhibition state during a charge readout period and a permission state during a period other than a charge readout period.

Referring to FIG. 7, even when the user presses the X-ray irradiation button during the second charge readout operation, since the rotor control signal indicates an inhibition state, the rotor does not start rotating. When the rotor control signal indicates a permission state after the completion of the second charge readout operation, the rotor starts rotating.

As described above, according to this embodiment, since the rotor does not rotate during charge readout operation, it is possible to reduce the possibility of the occurrence of artifacts in an image due to variations in the rotation of the rotor.

As described in the first to fourth embodiments, it is possible to reduce the possibility of the occurrence of artifacts in an image due to variations in the rotation of the rotor by reading out charge during a steady state in which the rotational speed of the rotor becomes a constant rotational speed, without performing charge readout operation during a deceleration period of the rotor.

The present invention can reduce the occurrence of artifacts in an image due to the influence of the rotation of the positive electrode of the radiation generating apparatus.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-096038 filed on Apr. 19, 2012, which is hereby incorporated by reference herein in its entirety.

What is claimed is:

1. A radiation imaging apparatus comprising:
an obtaining unit configured to obtain rotation control information of a positive electrode of a rotating positive electrode type radiation generating apparatus;
an accumulation unit configured to accumulate charge;
a readout unit configured to read out the charge based on the rotation control information while a rotational speed of the positive electrode is constant; and
an image generating unit configured to generate an image by reading out the charge.

2. The apparatus according to claim 1, wherein said readout unit reads out charge accumulated by radiation irradiated from the radiation generating apparatus while the positive electrode stops rotating, and said image generating unit generates a radiation image by reading out the charge, and
said readout unit further reads out charge in a state in which the radiation is not irradiated, a predetermined period after charge is read out to generate the radiation image, and said image generating unit generates a correction image for correcting an influence of a dark current by reading out the charge.

3. The apparatus according to claim 1, wherein said readout unit reads out charge accumulated by radiation irradiated from the radiation generating apparatus while a rotational speed of the positive electrode is constant, and said image generating unit generates a radiation image by reading out the charge, and
said readout unit further reads out charge in a state in which the radiation is not irradiated, a predetermined period after charge is read out to generate the radiation image while a rotational speed of the positive electrode is constant, and said image generating unit generates a correction image for correcting an influence of a dark current by reading out the charge.

4. The apparatus according to claim 3, wherein upon generating the correction image by reading out the charge a predetermined period after charge is read out to generate the radiation image while the positive electrode is rotating, said readout unit generates the correction image by further reading out charge while the radiation is not irradiated after the positive electrode stops rotating.

5. The apparatus according to claim 2, wherein the predetermined period is equal in length to a time during which charge accumulation is performed for generation of the radiation image.

6. The apparatus according to claim 2, wherein said image generating unit generates a correction radiation image on which an influence of the dark current has been corrected, by subtracting a luminance value of the correction image from a luminance value of the radiation image.

7. The apparatus according to claim 1, further comprising a determination unit configured to determine whether readout operation of charge for generation of a radiation image is complete before a rotation of the positive electrode begins to decelerate after the radiation is irradiated, based on a period measured in advance before a rotation of the positive electrode begins to decelerate after the radiation generating apparatus stops irradiating radiation.

8. The apparatus according to claim 7, wherein if said determination unit determines that readout operation of charge for generation of the radiation image is not complete before the rotation of the positive electrode begins to decelerate,
said readout unit reads out charge accumulated by radiation irradiated from the radiation generating apparatus after the positive electrode stops rotating, and said image generation unit generates the radiation image by readout operation of the charge, and
said readout unit further reads out charge in a state in which the radiation is not irradiated, a predetermined period after charge is read out to generate the radiation image, and said image generating unit generates a correction image for correcting an influence of a dark current by reading out the charge.

9. The apparatus according to claim 7, wherein if said determination unit determines that readout operation of charge for generation of the radiation image is complete before the rotation of the positive electrode begins to decelerate,
said readout unit reads out charge accumulated by radiation irradiated from the radiation generating apparatus while a rotational speed of the positive electrode is constant, and said image generating unit generates a radiation image by reading out the charge, and
said readout unit reads out charge in a state in which the radiation is not irradiated, a predetermined period after charge is read out to generate the radiation image while a rotational speed of the positive electrode is constant, and said image generating unit generates a correction image for correcting an influence of a dark current by reading out the charge.

10. The apparatus according to claim 8, wherein the predetermined period is equal in length to a time during which charge accumulation has been performed for generation of the radiation image.

11. The apparatus according to claim 8, wherein said image generation unit generates a corrected radiation image on which an influence of the dark current has been corrected, by subtracting a luminance value of the corrected image from a luminance value of the radiation image.

12. The apparatus according to claim 1, further comprising a control unit configured to perform control to inhibit the positive electrode from rotating while readout operation of the charge is executed.

13. A radiation imaging system comprising a rotating positive electrode type radiation generating apparatus and a radiation imaging apparatus,
said radiation imaging apparatus comprising
an obtaining unit configured to obtain rotation control information of a positive electrode of said radiation generating apparatus,
an accumulation unit configured to accumulate charge,
a readout unit configured to read out the charge based on the rotation control information while a rotational speed of the positive electrode is constant, and
an image generating unit configured to generate an image by reading out the charge.

14. A method of controlling a radiation imaging apparatus, the method comprising:
obtaining rotation control information of a positive electrode of a rotating positive electrode type radiation generating apparatus;
accumulating charge;
reading out the charge based on the rotation control information while a rotational speed of the positive electrode is constant; and
generating an image by reading out the charge.

15. A non-transitory computer-readable storage medium storing a computer program for causing a computer to execute each step in a method of controlling a radiation imaging apparatus defined in claim 14.

16. A radiation imaging apparatus comprising:
an obtaining unit configured to obtain rotation control information of a positive electrode of a rotating positive electrode type radiation generating apparatus;
an accumulation unit configured to accumulate charge;
a readout unit configured to read out the charge based on the rotation control information while a rotational speed of the positive electrode is constant, if preview display is not performed; and
an image generation unit configured to generate an image by reading out the charge.

17. A method of controlling a radiation imaging apparatus, the method comprising:
obtaining rotation control information of a positive electrode of a rotating positive electrode type radiation generating apparatus;
accumulating charge;
reading out the charge based on the rotation control information while a rotational speed of the positive electrode is constant, if preview display is not performed; and
generating an image by reading out the charge.

18. A non-transitory computer-readable storage medium storing a computer program for causing a computer to execute each step in a method of controlling a radiation imaging apparatus defined in claim 17.
